(19) United States
(12) Patent Application Publication
(10) Pub. No.: US 2013/0275951 A1
(43) Pub. Date: Oct. 17, 2013

(54) RACE DETECTION FOR WEB APPLICATIONS

(71) Applicants: Julian Dolby, Yorktown Heights, NY (US); Boris Petrov, Sofia (BG); Manu Sridharan, Boulder, CO (US); Martin Vechev, Yorktown Heights, NY (US)

(72) Inventors: Julian Dolby, Yorktown Heights, NY (US); Boris Petrov, Sofia (BG); Manu Sridharan, Boulder, CO (US); Martin Vechev, Yorktown Heights, NY (US)

(73) Assignee: International Business Machines Corporation, Armonk, NY (US)

(21) Appl. No.: 13/447,814

(22) Filed: Apr. 16, 2012

(51) Int. Cl. G06F 9/44

(52) U.S. Cl. 717/126

(57) ABSTRACT

A method of executing a rendering engine including executing a web application including at least two operations a single thread of execution, generating an auxiliary map for instrumentation accesses of the web application, and detecting and reporting concurrent memory accesses of the web application as a race.

### BACKGROUND

1. Technical Field

The present disclosure generally relates to web applications, and more particularly, to the detection of race conditions in web applications.

2. Discussion of Related Art

Modern web pages are increasingly becoming full-featured web applications, with rich user interfaces and significant client-side code and state. The web platform has significant advantages for application development, including quick deployment of updates, easier portability across desktops and mobile devices, and seamless client-server integration.

Web applications are making greater use of asynchronous constructs in the web platform as their functionality becomes richer. For example, user interactions and completion of certain network requests can be processed in an asynchronous, event-driven style by registering handlers for the events. Further, sites are making increasing use of delayed or asynchronous loading of JavaScript code itself, to speed rendering of other parts of the page and increase perceived responsiveness.

Use of asynchrony can lead to serious concurrency errors in web applications. Since the JavaScript code in web pages runs sequentially, there is less awareness of these concurrency errors than for languages like Java that have shared-memory multi-threading. Nevertheless, such errors can arise, due to non-determinism in event dispatch, network bandwidth, CPU speed, etc.

Concurrency errors have caused serious bugs in real-world web applications. Developers at Mozilla noticed that many of the non-deterministic failures in their regression test suite were due to race conditions in the unit test inputs, leading to documentation on how to avoid such problems. The Hotmail email service was broken in the Firefox web browser for some time due to a race, leading to a loss of message content.

### BRIEF SUMMARY

According to an embodiment of the present disclosure, a method for executing a rendering engine includes receiving computer readable code via a computer network, and rendering the computer readable code as displayed content in a single thread of execution, the rendering engine characterized by a happens-before relation for a plurality of operations of the rendering engine in rendering the computer readable code.

According to an embodiment of the present disclosure, a method for executing a rendering engine includes receiving computer readable code via a computer network, and rendering the computer readable code as displayed content in a single thread of execution, the rendering engine characterized by a model of logical memory locations for a plurality of memory-access operations of the rendering engine in rendering the computer readable code.

According to an embodiment of the present disclosure, a method of executing a rendering engine including executing a web application including at least two operations a single thread of execution, generating an auxiliary map for a plurality of instrumentation accesses of the web application, and detecting and reporting concurrent memory accesses of the web application as a race.

### BRIEF DESCRIPTION OF THE SEVERAL VIEWS OF THE DRAWINGS

Preferred embodiments of the present disclosure will be described below in more detail, with reference to the accompanying drawings:

FIG. 1 is a flow diagram of a race detection method according to be an embodiment of the present disclosure;

FIG. 2 is a general data race example according to be an embodiment of the present disclosure;

FIG. 3 is a data race on a form field value according to be an embodiment of the present disclosure;

FIG. 4 is an example of an HTML race according to be an embodiment of the present disclosure;

FIG. 5 is an example of a function race according to be an embodiment of the present disclosure;

FIG. 6 is an example of an event dispatch race according to be an embodiment of the present disclosure;

FIG. 7 is an example of element precedence according to be an embodiment of the present disclosure;

FIG. 8 is an example of an asynchronous script according to be an embodiment of the present disclosure;

FIG. 9 is a flow diagram of race detection according to be an embodiment of the present disclosure;

FIG. 10 is a flow diagram of an exemplary implementation of a race detector according to be an embodiment of the present disclosure; and

FIG. 11 is a diagram of a computer system for implementing a method for applying analytics for case management according to an embodiment of the present disclosure.

### DETAILED DESCRIPTION

According to an embodiment of the present disclosure, concurrency errors in web applications may be detected. A concurrency error occurs when asynchronous events lead to race conditions in conjunction with the rendering of the web application. The concurrency errors may result in loss of data or improper functioning of the web application. These errors are difficult to discover in web application because they can depend on user interaction. According to an embodiment of the present disclosure, a “happens-before” relation over website constructs and a “logical model” of memory accesses for capturing stateful interactions are described. The logical model and happens-before relation enable the ability to detect race conditions in web applications that can cause concurrency errors.

To clarify the behavior of asynchrony in web applications, an exemplary happens-before relation is described for commonly used JavaScript and HTML features. Defining a happens-before relation is non-trivial, due to complex interactions between JavaScript and standard HTML features and browser deviations from the specification. The creation of exemplary happens-before relations may be based on study of relevant specifications, browser behaviors, and how constructs are used in practice.

According to an embodiment of the present disclosure, an exemplary model is described for logical memory locations accessed by various web platform features, for building tools like a race detector. Typically, memory accesses can simply be defined as those reads and writes occurring at the machine or virtual-machine level. However, for web applications, there is no obvious definition of machine-level accesses, as operations may access JavaScript heap locations, locations implemented in browser-specific native data structures, or both. The exemplary model of logical memory locations enables reasoning about these memory-access operations in a browser-independent manner.

Based on the exemplary happens-before relation and exemplary logical memory locations, a racer detector is described for dynamic race detection in the context of web applications. The dynamic approach lets the racer detector precisely handle many complex features of web applications that would be difficult to handle with static analysis alone. The JavaScript language has many difficult-to-analyze constructs, like prototype chains and the eval( ) method, that are used frequently in real-world applications. The racer detector can observe the relevant effects of these constructs. Further, the racer detector precisely handles interactions between JavaScript and HTML via the Document Object Model (DOM) data structure, a tree representation of the HTML that may be queried via string matching of node identifiers. The racer detector is able to find races at the level of concrete DOM tree nodes (i.e., individual HTML elements) by observing accesses to memory addresses. The racer detector is also able to simulate certain user interactions with sites for exposing races.

An exemplary implementation of the race detector may be built on WebKit, a robust rendering engine used in many production browsers. It should be understood that embodiments described in the present disclosure are not limited to WebKit, and that a race detector may be built on various rendering engines, for example, Gecko.

Referring now to the figures; the flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

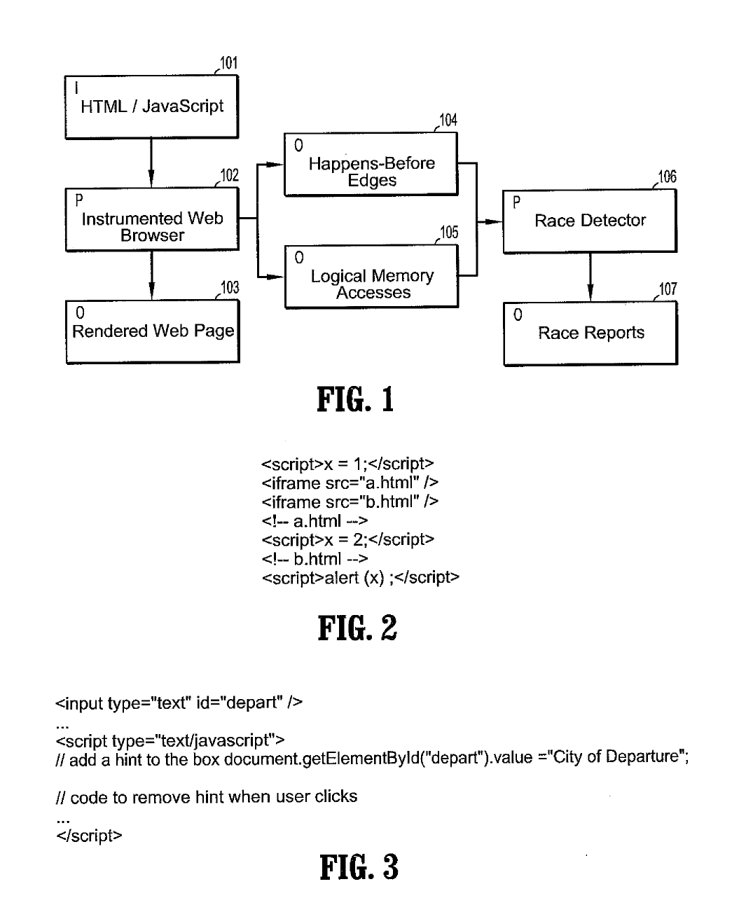

Referring to FIG. 1, a flow diagram of a race detection method is show, wherein blocks are labeled as input “I”, processor actions “P”, or output “O”. Output may include intermediate data structures. According to FIG. 1, an input is received at block 101. The input may be HTML, JavaScript, or a combination thereof provided by a computer server. A processor executes a web browser (102) to produce an output, in this case render the input at a web page (103). The web browser further outputs happens-before edges (104) and logical memory accesses (105). A happens-before edge is a pair (X, Y), where X and Y are operations (described herein). The web browser outputs the happens-before edges according to a first set of rules (described herein). A logical memory access is a triple (A, L, T) where: A is an operation, L is a logical memory location, and T is either a read or write. The web browser outputs logical memory access info according to a second set of rules (described herein). The processor executes a race detector (106), taking the happens-before edges (104) and logical memory accesses (105) as input to produce a race report (107).

Sources of Races

For purposes of the present disclosure, the execution of a web application can be seen as including the conversion of HTML into a DOM tree and the execution of scripts containing JavaScript code. Typically in modern browsers, these activities are interleaved in a single thread of execution, prohibiting many types of concurrency (e.g., two distinct scripts cannot execute concurrently). The traditional definition of a data race involving two unordered memory accesses (one of which must be a write) from distinct execution threads may not apply.

Races in web application may arise from environmental asynchrony, typically triggered via event dispatch. The web platform employs an event-based programming model to handle a variety of external events—pages may register handler code to be executed after user interactions (e.g., a mouse click) or the completion of some page loading operation, etc. Scripts may also explicitly queue functions to execute after some amount of time via the setTimeout or setInterval methods. These event handler functions may execute in a non-deterministic order due to a variety of factors, e.g., variation in network bandwidth, CPU resources, or the timing of user input events.

Asynchronous events may lead to race conditions in conjunction with a web browser's rendering of a partially-loaded page.

During the page load process, modern browsers aggressively attempt to render the HTML and JavaScript code as it is downloaded, thereby improving perceived browser performance. When a partially-loaded page is rendered, user interactions may be interleaved with the remainder of the page load process in an unexpected manner, leading to race conditions. Furthermore, web application authors often exploit partial page rendering by deliberately delaying the download and execution of certain script code. In such cases, the page appears to load quickly, but some code required for user interaction may not yet be loaded, again leading to races.

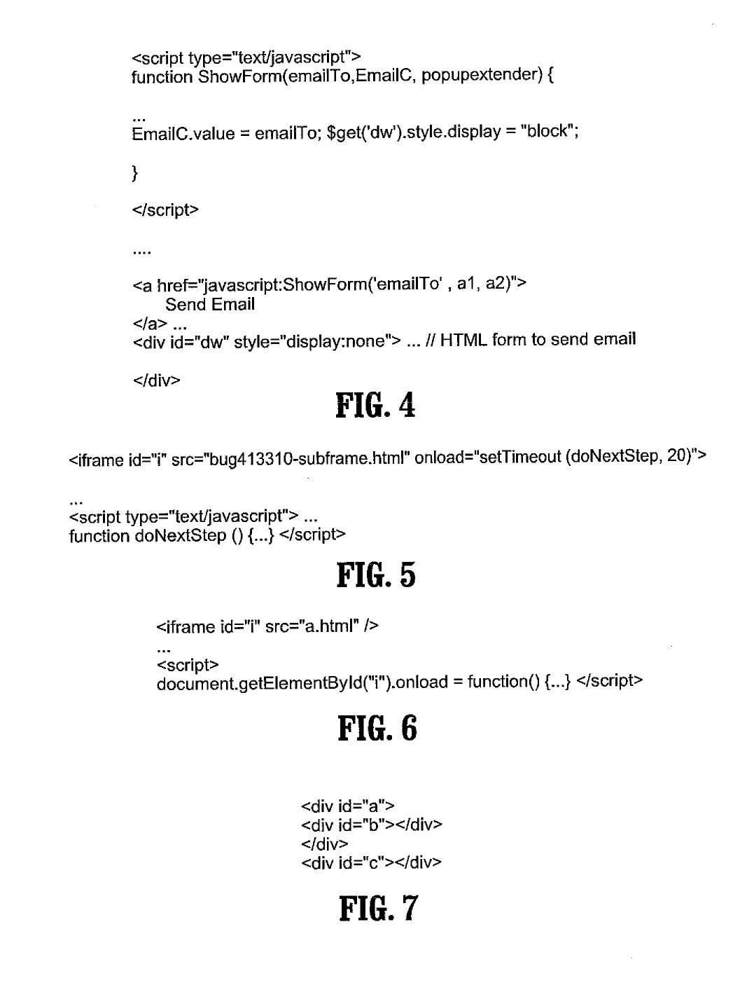

These exemplary issues are illustrated herein with four types of data races. More particularly, a data races on JavaScript memory locations is illustrated in FIGS. 2 and 3. Races specific to the web platform are illustrated in FIGS. 4-6, showing, HTML races, function races, and event dispatch races, respectively. These race types are distinguished since the racing accesses do not always appear as standard memory accesses in the JavaScript code.

Variable Races

As in many other languages, web applications may have data races on JavaScript memory locations. A simple example appears in FIG. 2. Here, a variable x is set to 1 in the global scope. Then, two iframe elements are created; an iframe contains the content of some other HTML file, loaded asynchronously. In this case, the iframes cause a.html and b.html to be loaded asynchronously. The script in b.html may display 1 or 2 depending on when the script in a.html is executed, a clear data race.

Note that in FIG. 2, the first write x=1 does not race with the writex=2 in a.html, since the first script will always execute before the iframes are loaded. The happens-before relation accurately captures such orderings between HTML element parsing and script execution.

Data races may also occur on properties of a DOM node (representing an HTML element), potentially making them more directly visible (and annoying) to the user. Consider the example of FIG. 3, a simplified version of a real bug discovered in an airline's web site. First, an input element is created in which the user can type their departure city for a flight search. Later in the page, a script sets the value in the input box to “City of Departure”, as a hint to the user, and adds code to make the hint text disappear when the user clicks in the box (not shown). Here, the non-determinism stems from partial page rendering: the user may see and interact with the input text box before the script loads and runs, and if this occurs, the script will simply overwrite any text that the user has entered. An exemplary race detection tool according to an embodiment of the present disclosure may discover this type of bug automatically by simulating certain user interactions.

HTML Races FIG. 4.

Certain web application data races are more unique to the semantics of the web platform and JavaScript. An HTML race occurs when an access of a DOM node representing an HTML element may occur before or after its creation. Consider FIG. 4, based on code with a race from an energy corporation. Here, the div with id dw holds an HTML form for sending email, hidden by default (since the value of the style attribute is display: none). When the user clicks the “Send Email” link, the ShowForm( ) JavaScript function executes and the style of dw is changed, making the form appear. (The $get function employed by ShowForm( ) is essentially equivalent to the document.getElementById( ) function.)

The race arises if the user clicks the “Send Email” link before the dw element has loaded. In this case, the ShowForm( ) function will attempt to set the style of a non-existent element, leading to an exception being thrown and termination of JavaScript execution. Web browsers are designed to hide many “bad” JavaScript behaviors, and in this case, the JavaScript crash will not be shown to the user—the link will simply appear to do nothing when clicked, and subsequent scripts will continue to be executed. These hidden crashes can mask more serious problems, as mutations to global JavaScript state preceding the crashes persist, possibly leaving objects in an inconsistent state. In FIG. 4, the effect of the statement EmailC.value=emailTo in ShowForm( ) will remain even if the subsequent statement accessing dw crashes, potentially affecting execution of subsequent scripts on the page.

Note that for this case, it is not obvious which “memory location” the operations race upon. Within a browser implementation, the concrete memory location(s) involved may depend on how exactly the DOM data structure is implemented. In a model of happens-before and logical memory according to an embodiment of the present disclosure, a logical HTML element location t for the dw element, with the JavaScript $get call reading l and the browser's parsing of the div node writing l. In this manner, the data race can be modeled independent of browser implementations.

Function Races—FIG. 5

Similarly to an HTML race, a function race occurs when an invocation of function ƒ may occur before or after the parsing of ƒ. FIG. 5 gives an example of a function race, extracted from a Mozilla Firefox unit test that was failing non-deterministically. Here, an iframe whose onload handler (executed after the src HTML file is loaded) uses setTimeout( ) to perform a delayed invocation of doNextStep( ), is declared in the later script tag. In this case, even with the 20 ms delay, doNextStep( ) may be invoked before its declaring script is loaded if the iframe's HTML loads quickly. Invoking a non-existent function in JavaScript causes an exception, which in this case would cause the corresponding unit test to fail. In general, these exceptions may lead to the same types of problems described above with HTML races, due to JavaScript code possibly being terminated in an inconsistent state. Here, the race may be fixed by moving the script element above the iframe, in which case our happens-before relation would show that doNextStep( ) is always parsed before being invoked.

Event Dispatch Races—FIG. 6

An event dispatch race occurs when an event may fire before or after some handler for that event is added. FIG. 6 is an example of such a race. Here, the onload handler for an iframe is set in a separate script, rather than directly in the iframe tag via the onload attribute. Third-party scripts included in a page often add event handlers in this way, since they cannot modify attributes in the HTML source directly. In the example of FIG. 6, it is possible that the iframe's load event will fire even before the script executes (if the iframe loads very quickly), in which case the installed onload handler will never run.

Note that for this example, one racing “access” is the read of the iframe's onload handler by the browser when the iframe's load event is dispatched—this read is not explicit in the HTML or JavaScript code. The exemplary model of happens-before and logical memory can both expose this race and also show that there is no race if the iframe's onload attribute is set in the tag itself.

Happens-Before

An example of the happens-before relation is described that captures ordering constraints for features of the web-platform.

Note that defining the happens-before relation can be challenging because relevant specifications can be vague and browsers may differ on how they implement the specification. The exemplary definition of the happens-before relation agrees with both the specification and how major browsers work. In cases, where the specification was unclear or behavior differed significantly across browsers, happens-before edges may be omitted in order to not miss races.

An HTML page includes a tree of elements. Each element is typically delimited with an opening and a closing tag, e.g., <p> . . . </p> for a paragraph element. Within an HTML page, element e1 precedes element e2 if e1's opening tag appears syntactically earlier than e2's opening tag. For example, in FIG. 7, element a precedes elements b and c, and element b precedes element c.

A static HTML element is declared syntactically in the page; elements may also be inserted by scripts.

Scripts and the DOM

JavaScript code is added to a page via <script> elements. A static script element is inline if its code is declared in its body, e.g., <script>x=10;</script>. Otherwise, a script element is external, and its code resides in a file specified via the src attribute, e.g., <script src=“code.js”></script>. A detailed description of the JavaScript programming language is omitted.

The Document Object Model (DOM) tree is a parsed representation of a page's elements that gets rendered by the web browser and possibly accessed or mutated by scripts. Each node in the DOM tree has attributes to hold meta-data, including attributes that mirror those seen in the corresponding HTML tag (e.g., a node representing a <script> element may have a src attribute). Scripts can add or remove nodes from the DOM, leading the web browser to update its page rendering. Scripts may also insert new script nodes into the DOM to make the browser load and execute new code (possibly asynchronously); a script added in this manner is script-inserted. As with static <script> elements, a script-inserted script is inline if its code is present as a child node and external if the code location is in its src attribute.

Asynchronous and Deferred Scripts

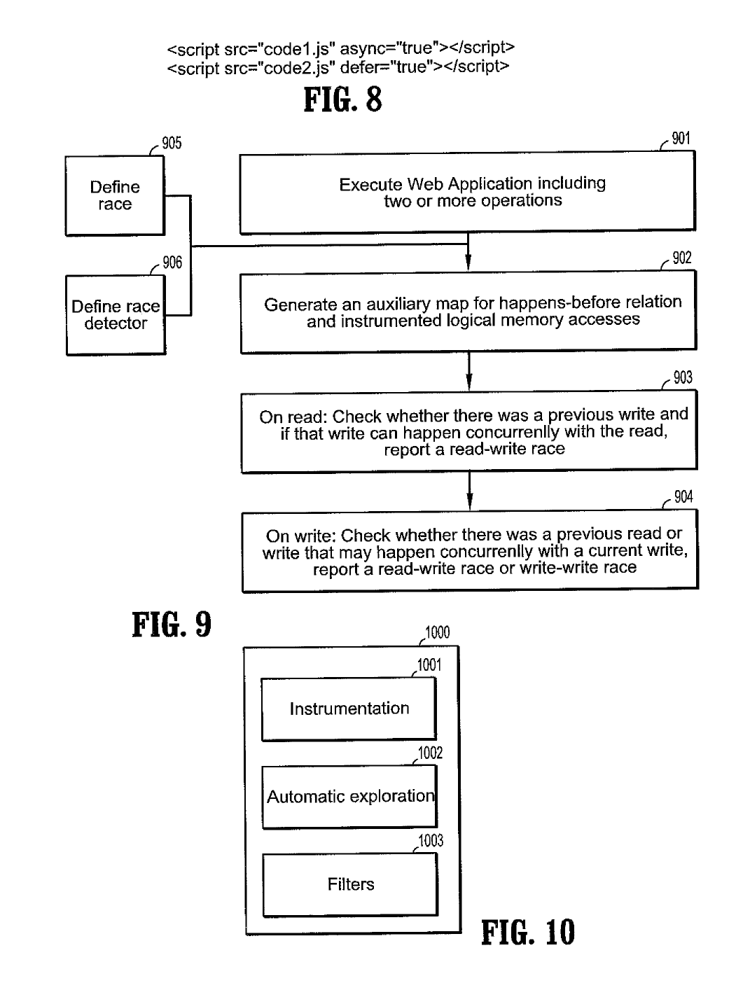

Both static script elements and script-inserted scripts may be declared as asynchronous or deferred via attributes. Intuitively, a deferred script should run after all static HTML elements have been parsed, while an asynchronous script may run at any time. An asynchronous script has a Boolean async attribute with value true, and a deferred script has a similar defer attribute, for example see FIG. 8.

Asynchronous and deferred scripts must be external (i.e., their src attribute must be set), and a script cannot be both asynchronous and deferred. An external script that is neither asynchronous nor deferred is a synchronous script.

Frames

HTML pages may be embedded in inline frames in other pages via the <iframe> tag, e.g.: <iframe src=“nested.html”></iframe>

The HTML in an inline frame is loaded asynchronously, making iframes interesting from a happens-before perspective. The root HTML page and each (transitive) inline frame have their own window objects, and each window has an associated document object, essentially the root of the corresponding DOM tree.

Events and Handlers

Web applications are typically written in an event-driven style, registering handler scripts to be executed when various types of events occur. Events are dispatched, e.g., for user interactions (clicks, typing, etc.) and the completion of loading various elements (images, scripts, etc.). Every event has a target denoting the object upon it was dispatched (e.g., for a click event, the DOM node for the button that was clicked).

Asynchronous networks requests (“AJAX” requests) are made by invoking send( ) on some XmlHttpRequest object o. At various stages of the request (including completion), the readystatechange event is dispatched with target o.

For simplicity, inline event dispatch and propagation of events through a DOM tree have been ignored (though they may be fully handled by implementations).

DOM content and window load Two events of particular interest are the DOMContentLoaded event on a document, indicating (roughly) that the static HTML for the document has been parsed, and the load event on a window, fired after resources like images and inline frames have fully loaded. Scripts very often register handlers on these events to perform additional computation once other resources have been loaded, so capturing their happens-before relationships precisely is important.

Timed Execution

The setTimeout and setInterval functions can be used to perform delayed execution of some script code. A call setTimeout (ƒ, i) causes ƒ to be executed i milliseconds or later.setInterval (ƒ, i) is similar, but it executes ƒ every i milliseconds. Due to their timing-dependent behavior, happens-before is captured before these functions.

Operations

Each operation has a unique identifier taken from the set OpId.

Two types of atomic operations during web page loading include: (1) parsing of HTML and (2) execution of script code. parse(E) is used for the operation that parses a static HTML element E. For convenience, script execution operations may be separated into different types:

exe(E): the operation executing the source in a script element E (either static or script-inserted).

The execution of an event handler due to an event dispatch.

cb(E): the execution of the callback script E resulting from a setTimeout (E, _) call.

cbⁱ(E): the execution of the i'th invocation (i≧0) of a callback script E resulting from a setInterval (E, _) call.

Helper functions related to operations may be used. For example:

create(E) denotes the operation that inserts an element E into a document (i.e., a DOM tree). If E is a static HTML element, then create(E)=parse(E). Otherwise, create(E) is the operation associated with the script that inserts E.

dispᵢ(E, T) denotes the set of operations that execute all event handlers for the i'th dispatch of event E at target T.

d(T) denotes disp₀(load, T), if T has a load event.

dcl(D) denotes disp₀(DOMContentLoaded, D) for a document D.

Building the Happens-Before

The happens-before relation, denoted [symbol] , is a binary relation on operation identifiers, i.e. [symbol] ⊂OpId×OpId. As a shortcut A [symbol] B is used to mean (A, B)ε [symbol] and A [symbol] B to mean (A, B)ε [symbol] . When it may be said that that two operations are in the happens-before, the identifiers of these operations are being referred to.

A happens-before may be defined between an operation A and all operations found in a set B. A [symbol] Bₛ indicates which parameter is the set. Then, A [symbol] Bₛ means that ∀(a, b)ε{A}×Bₛa [symbol] b. The definitions of Aₛ [symbol] B and Aₛ [symbol] B, are similar.

Rules may be grouped for constructing the happens-before in roughly the same order as the corresponding features.

Static HTML Elements in static HTML are essentially processed in syntactic order, i.e.:

1. Let E₁ and E₂ be two static HTML elements in the same document, such that E₁ precedes E₂ (see Section 3.1). Then:

(a) parse(E₁) [symbol] parse(E₂).

(b) if E₁ is an inline script, exe(E₁) [symbol] parse(E₂).

(c) if E₁ is a synchronous script, ld(E₁)ₛ [symbol] parse(E₁).

Script Parsing, Execution, and Loading

The following basic rules govern all script elements E:

2. create(E) [symbol] exe(E)

3. exe(E) [symbol] ld(E)ₛ (except for inline scripts, which have no load event)

Note that script-inserted inline scripts execute synchronously and their code does not execute as part of a new operation.

Asynchronous and Deferred Scripts Static deferred scripts execute in syntactic order after the DOM content has been loaded, captured with the following rules.

Let E be an element in a document D such that create(E) [symbol] dcl(D) and let S be a static deferred script element in D. Then create(E) [symbol] exe(S).

5. If E₁ and E₂ are static deferred script elements, and E₁ precedes E₂, then ld(E₁)ₛ [symbol] exe(E₂).

Asynchronous scripts and external script-inserted scripts may execute in any order. Apart from rules 2 and 3, such a script may only be governed by rule 15, relating its load event to that of the containing window.

Inner Frames The HTML nested in an iframe element I loads asynchronously, with the following constraints:

6. For any element E in the nested document for I, create(I) [symbol] create(E).

7. I's load event fires after the load event for the nested window W_{I}, i.e., ld(W_{I})ₛ [symbol] ld(I)ₛ.

Event Handlers

Some rules apply to event handler execution. Consider Aεdispᵢ(e, T) for some i≧0, event e, and target T.

8. The target must have been created previously: create(T) [symbol] A.

9. For any Bεdispᵢ(e, T), where 0≦j<i, B [symbol] A.

For AJAX requests the following rule may apply:

10. Let A be the operation invoking send( ) on an XmlHttpRequest object T. Then, A [symbol] disp₀(readystatechange, T)s.

DOM Content and Window Load

These rules define happens-before relationships for the DOMContentLoaded event on a document and the load event on a window, in addition to rule 7. Beginning with a rule related the two:

11. Let D be the document of a window W. Then dcl(D)ₛ [symbol] ld(W)ₛ.

The following rules indicate which operations must happen before the DOMContentLoaded event for a document D:

12. Let E be a static HTML element in D. Then parse(E) [symbol] dcl(D)ₛ.

13. Let E be a static inline script element in D. Then exe(E) [symbol] dcl(D)ₛ.

14. Let E be a static synchronous or deferred script element in D. Then ld(E)ₛ [symbol] dcl(D)ₛ.

The following rule shows which events must precede the load event for a window W:

15. Let E be an element in the document of W for which create(E) [symbol] ld(W)ₛ holds and which has a load event (e.g., an img or script element). Then ld(E)ₛ [symbol] ld(W)ₛ.

Note that due to rule 3, rule 15 also relates the execution of scripts and the window load event.

Timed Execution

Rules governing setTimeout and setInterval executions are also disclosed:

16. Let A be an operation which calls setTimeout (B, _). Then A [symbol] cb(B).

17. Let A be an operation which calls setInterval (B, _). Then A [symbol] cb⁰(B) and ∀i≧0.cbⁱ(B) [symbol] cbⁱ⁺¹(B).

Memory Accesses

Various shared memory accesses may be performed by an operation. The notion of memory access is complicated by the fact that the web platform has no natural definition of “machine-level” accesses, as common operations manipulate both JavaScript heap locations and browser-internal data structures (e.g., DOM operations). Here, in addition to the JavaScript variables, HTML elements in the DOM and event handlers have been identified as logical locations accessed by operations. Accesses to these locations have been defined in a browser-independent manner, easing high-level reasoning. Each type of location is discussed in turn.

Accesses on Variables

Let JSVar be the set of JavaScript variables that could potentially be shared among different operations. Such variables may include:

Local variables (which could be shared between different operations via a closure).

Object properties (instance fields and array element).

Global variables (which are technically properties of a “global object”).

Here, by JSVar refers to the set of variable addresses computed in the semantics of JavaScript. For instance, the variable name and scoping rules of JavaScript are used to determine the variable address. Reads and writes of these addresses x are potential shared memory accesses.

Functions

A function definition named F (i.e. not a lambda function) in JavaScript scope S may be treated as a write of an anonymous function with F's body to a local variable named F, where the local variable assignment is placed at the beginning of scope S, in accordance with JavaScript semantics. For example, the following:

{ // scope S

some_statements A;
function foo( ) {some_statements B;}

some_statements C;

function bar( ) {some_statements D;}

}

is treated as:

{ // scope S

var foo = function( ) {some_statements B;};
var bar = function( ) {some_statements D;};
some_statements A;
some_statements C;

}

Additional Cases

The following accesses are also writes on object properties:

Adding/removing a child element B to/from an element A (whether statically or dynamically) is considered a write to B's parentNode property and a write to A's childNodes [i]property, where i is the index of B in the childNodes list.

Modification of an HTML form element is treated as a write to the corresponding DOM node attribute. For example, the user typing into an input or textbox element is considered a write to the element's value attribute, clicking a checkbox writes its checked property, etc.

Accesses on HTML Elements

Let HElem denotes the set of HTML elements. Then:

Write Accesses

The following write to an HTML element e:

Inserting e (either via static parsing or dynamic JavaScript insertion) into a document. Dynamic insertion of an HTML element also dynamically inserts all of its child elements. The appendChild and insertBefore functions in JavaScript are examples of ways to dynamically insert elements.

Removing e (dynamically via JavaScript) from a document (which also removes its child elements). The removeChild function in JavaScript is an example of a way to dynamically remove an element.

Read Accesses

JavaScript code can perform a logical read of an HTML element e via accessor methods or direct reads. Examples include:

document.getElementById, document.body,
document.getElementsByName, document.forms[i],
document.getElementsByTagName, document.images[i],
document.childNodes[i], document.anchors[i],
document.links[i], document.scripts[i]

Accesses on Event Handlers

The combination of a target element el, event e and event handler h defines a logical event handler location (el, e, h)εEloc. Note that by having h in the logical location instead of only el and e, accesses are allowed that manipulate disjoint handlers for the same event e (these accesses do not interfere).

Write Accesses

The following accesses write an event handler location:

Parsing of an element with an event handler content attribute (see “Event Handler Content Attribute” in the specification [10]), for example parsing the following:

<img id=“g” onload=“doWorkA( )”></img>

Writing the event handler attribute (see “Event Handler IDL Attribute” in the specification) of an element, for example:

document.getElementById(“g”).onload=“doWorkB( )”

Invoking the addEventListener function, for example: document.getElementById(“g”).addEventListener(“load”, someFunc)

Invoking the removeEventListener function, for example: document.getElementById(“g”).removeEventListener(“load”, someFunc)

Read Accesses

An event handler location (el, e, h) is read when executing event handler h due to an event dispatch of event e with current target el. An event dispatch could be initiated by a user (e.g., clicking a button) or programmatically (e.g., calling el.focus( ) to dispatch a focus event on element el).

Referring now to FIG. 9, a data race (905) may be defined along with a dynamic data race detector (906).

Definition of a Race (905)

From the definition of happens-before and memory accesses, a race may be defined as follows. Let A, A′ε{read, write}×Op(A′) be memory accesses to some logical location m in an execution. A race exists between A and A′ if:
op(A)≠op(A′) (accesses are performed by different operations).
op(A) [symbol] op(A′) and op(A′) [symbol] op(A) (the operations are not in the happens-before).
kind(A)=write or kind(A′)=write (one of the accesses is a write).

In the above, op gives the operation identifier for an access, and kind gives the access type (read or write).

It may be assumed that an exemplary race detector is running on a machine executing a web application including two or more operations (901). The race detector may be defined at the declarative level (906). An auxiliary map Aux may be maintained for instrumentation accesses, including happens-before relations and instrumented logical memory accesses (902):

AuxεLoc→Id×Id

Here, Loc=HElem [symbol] JSVar [symbol] Eloc and Id={⊥} [symbol] OpId. For each location, the map may maintain two fields: the first field is the identifier of the operation that last read the location, and the second is the identifier of the last operation that wrote the location. For convenience, a function CHC has been defined to mean Can-Happen-Concurrently as:

CHCεOpId×OpId→Bool

CHC(A, B)=A≠⊥ [symbol] B≠⊥ [symbol] A [symbol] B [symbol] B [symbol] [symbol] EMBED Equation. 3

[symbol]

Intuitively, two operations A and B can happen concurrently when both are not equal to ⊥ and (A, B) and (B, A) are not in the happens-before relation.

A race detection algorithm may work as follows: at the start, all entries in the map are initialized, i.e. Aux[e]:=∞×∞.

Then, upon an access A to an element e □ Loc:

If kind(A)=read:

1. Report a race if CHC(Aux[e][1], op(A))=true.

2. Aux[e][0]:=op(A).

If kind(A)=write:

1. Report a race if:
CHC(Aux[e][1], op(A))=true, or
CHC(Aux[e][0], op(A))=true

2. Aux[e][1]:=op(A).

That is, on a read, it may be checked whether there was a previous write and if that write can happen concurrently with the read, report a read-write race (903). Similarly, on a write, it may be checked whether there was a previous read or a write that can happen concurrently with the current write, and if so, report a read-write or a write-write race (904). Note that a constant amount of auxiliary information is kept per memory location: a read or a write access will always overwrite its corresponding slot in the location. One implication is that the algorithm will scale well with the number of operations (as the space overhead per memory location is constant).

Implementation

An exemplary race detector (1000) is described with reference to FIG. 10. The race detector may be implemented in WebKit with an automatic exploration functionality for simulating user interactions. Although a particular race detector is described here, the framework is flexible and allows any dynamic race detector to be plugged in, for example, one may implement an adapted version of FastTrack.

Instrumentation (1001)

It may be difficult to find all the relevant instrumentation points in WebKit to capture the happens-before relation and logical memory accesses needed for the race detector. The reason is that WebKit has no single intermediate representation (IR) where all the relevant operations are exposed. This is in contrast to say JVM bytecodes, where finding the right bytecodes to be instrumented is straightforward. While WebKit's JavaScript interpreter does have an IR, the detector intercepts HTML parsing, event dispatch, parsing of new JavaScript functions, etc. Adding instrumentation required careful study of the WebKit code base in order to find the appropriate modification points.

Instrumentation for most commonly-used web features may be implemented in the race detector. The race detector may be adapted to handle new or additional features. For not yet implemented happens-before edges, the missing happens-before edges may lead to false positive races, but not false negatives.

It may be useful to have a well-defined, standard instrumentation interface for browsers that analysis tools like the race detector may be built upon.

Automatic Exploration (1002)

The race detector may allow for manual browsing and interaction with web sites to discover races. To further automate this process, automatic exploration systematically dispatches events corresponding to user actions. Automatic exploration may be useful, as it may avoid having to manually trigger each event on each site (a tedious and slow process).

Automatic exploration works by generating any event of certain types for which an event handler was registered by the page. Automatic dispatch of events may be performed together after the window load event is dispatched, simplifying reasoning about the race detector's output, since all automatically-dispatched events are together. Exemplary events that may be dispatched automatically include: mouseover, mousemove, mouseout, mouseup, mousedown, keydown, keyup, keypress, change, input, focus and blur. Additionally, clicks may be generated on links that had JavaScript as protocol in their href's.

Automatic exploration may be augmented to expose races on the contents of text boxes and input fields (like the race in FIG. 3). Exposing such races was non-trivial, since simply typing in a text box does not modify the value property of the corresponding DOM object (the location that can be accessed by scripts). A handler may be added for the input event to all text boxes and input fields that effectively contains the code this.value:=this.value. With this handler, any typing in a text box immediately updates the corresponding DOM node's value property. The race detector may also simulate typing into all text boxes.

Filters (1003)

A system is described from adding post-processing filters to the race detector's output, to heuristically filter out certain races. Such filters can be useful, e.g., for helping to focus attention on races more likely to reflect application bugs. In running the race detector on production web sites written by others, the following exemplary filters (focus on form races and focus on single-dispatch events) have been implemented:

Regarding the focus on form races; this filter suppressed all variable races that did not involve the value of some HTML form field, e.g., the value in an <input> text box. Races on form field values have a high potential to be harmful, as they involve potential side effects of user inputs (see FIG. 3). As an additional enhancement, races on HTML form fields in which the operation(s) writing the form field value v had a read of v preceding the write may be filtered out. Such reads often check to ensure that the user has not modified the field, which makes the race harmless.

Regarding the focus on single-dispatch events; this filter retained only event dispatch races involving events that dispatch at most once, e.g., the load event for a window. Races on such events are more likely to be harmful since once the event is dispatched, an added handler will never be run. In contrast, a click event on a button may dispatch multiple times, and missing one of those clicks is less likely to be a serious issue.

Note that these exemplary filters may be useful specifically for finding harmful races in deployed web sites. In a scenario where a developer or tester is checking her own web site for races, different (or no) filtering may be more suitable.

The follow is a description on an exemplary implementation of happens-before rules for event handlers. Firing an event E is done on an element or object T (called a target). Some events can have different phases associated with it: Capturing, At-Target, Bubbling and Default. The Capturing phase goes through all targets starting at the top of the DOM tree (at the document/window object) and moving down towards the event target T. At each target, all handlers that are registered for that type of event are executed. After the Capturing phase, the At-Target phase follows, which dispatches all handlers on the event target T. Following is the Bubbling phase, which works from the target T up towards the document/window object and dispatches the event on all targets on the way. The default action follows the Bubbling phase and dispatches on the target T. For example, on a link element, the href may be followed or executed if it is JavaScript code (i.e., of the form href=“javascript: . . . ”).

An inline event dispatch is the act of programmatically firing an event from JavaScript. An example would be the call element.click( ) in JavaScript code, which fires a click event on element. Anything else is considered as a non-inline event dispatch. An example would be the mousemove event firing due to the user moving her mouse, the load event for a window firing or the readystatechange event dispatching on an XMLHttpRequest object.

Since script execution is atomic, the browser will not preempt a script in order to execute a different script, parse more HTML, etc. Event-handler execution may be triggered in the middle of JavaScript code due to an inline event dispatch. Let A be such a JavaScript operation that is interleaved with event-handler execution. Given an execution A, A_{[i:j)} is the subsequence of A starting and including the i'th transition in A and ending with but not including the j'th transition (if i<0, j≧|A|, or i=j, then A_{[i:j)}=ε). Then, given an execution A interrupted by an inline event dispatch, let the event dispatch invocation be the k'th transition in A's execution. Let B be the set of operations generated by the inline event dispatch. Then:

A_{[0:k)} [symbol] Bₛ

Bₛ [symbol] A_{[k+}1:|A|)

A_{[i:j)} in the happens-before relation refers to the creation of a unique operation identifier for this sequence of transitions. Then, in the happens-before, an interleaved operation A may be replaced with the set {A_{[0:k)}, A_{[k+1:|A|)}}∪B.

Referring to an example of an event phasing happens-before, denote hop(E, ET, P, T), as the set of all operations that are the executions of all handlers for the i'th dispatch of event E dispatched on target ET in phase P with current target T. Let Aεhop(E₁, ET₁, P₁, T₁)ᵢ and Bεhop(E₂, ET₂, P₂, T₂)ⱼ. If E₁ and E₂ are both non-inline events, ET₁=ET₂, E₁=E₂, and (i<j or (i=j and (P₁≠P₂ or T₁≠T₂))), then A [symbol] B.

Browser specific behavior; It is possible that the HTML5 specification is imprecise in describing where happens-before edges need to be formed. Consider the following example:

<script type=“text/javascript”>
setTimeout(A, 5); // invoke A after time out 5
setTimeout(B, 2); // invoke B after time out 2
</script>

In the example, it is not certain whether the execution of A always happen before B (or vice versa), whether the timeout values 2 and 5 are reversed, or whether one should not assume any happens-before. In the exemplary definition of happens-before, a happens-before edge is not created between A and B (to err on the safe side of not missing races).

Even if the HTML5 specification is precise in describing the happens-before, it is possible that browsers deviate from it. An example is the order in which event handlers should be executed during event dispatch, where both Firefox and WebKit deviate from the specification.

<button id=″test″>Start Demo</button>
<script type=″text/javascript″>
var button = document.getElementById(’test’);
button.addEventListener(
’click’, function ( ) { alert(’ONE’) }, false);
// event handler listener is registered here
button.setAttribute(
’onclick’, ″alert(’NOT CALLED’)″);
button.addEventListener(
’click’, function ( ) { alert(’THREE’) }, false);
button.onclick = function ( ) { alert(’TWO’); };
button.addEventListener(
’click’, function ( ) { alert(’FOUR’) }, false);
</script>

This example is taken directly from the HTML5 spec. The spec says that alerts with “ONE”, “TWO”, “THREE”, and “FOUR” respectively should pop-up. Firefox, however, displays “ONE”, “THREE”, “TWO” and “FOUR”.

Consider the following buggy test case:

<html>

<head>
</head>
<body onload=″print(’loadbody/’);″>

<script defer src=″def.js″

onload=″append(’loaddef/’)″ />

<script type=″text/javascript″>

document.addEventListener(

″DOMContentLoaded″,
function( ) print(″DOMContentLoaded/″);

);

</script>

</body>

</html>
<!-- def.js -->
print(’rundef/’)

According to the HTML5 specification, the output of the above should be: rundef/loaddef/DOMContentLoaded/loadbody/

Google Chrome and Safari produce the above output. However, Firefox erroneously runs deferred scripts after DOMContentLoaded has fired, yielding: DOMContentLoaded/rundef/loaddef/loadbody/

The methodologies of embodiments of the disclosure may be particularly well-suited for use in an electronic device or alternative system. Accordingly, embodiments of the present disclosure may take the form of an entirely hardware embodiment or an embodiment combining software and hardware aspects that may all generally be referred to herein as a “processor”, “circuit,” “module” or “system.” Furthermore, embodiments of the present disclosure may take the form of a computer program product embodied in one or more computer readable medium(s) having computer readable program code stored thereon.

Any combination of one or more computer usable or computer readable medium(s) may be utilized. The computer-usable or computer-readable medium may be a computer readable storage medium. A computer readable storage medium may be, for example but not limited to, an electronic, magnetic, optical, electromagnetic, infrared, or semiconductor system, apparatus, device, or any suitable combination of the foregoing. More specific examples (a non-exhaustive list) of the computer-readable storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus or device.

Computer program code for carrying out operations of embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments of the present disclosure are described above with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions.

These computer program instructions may be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

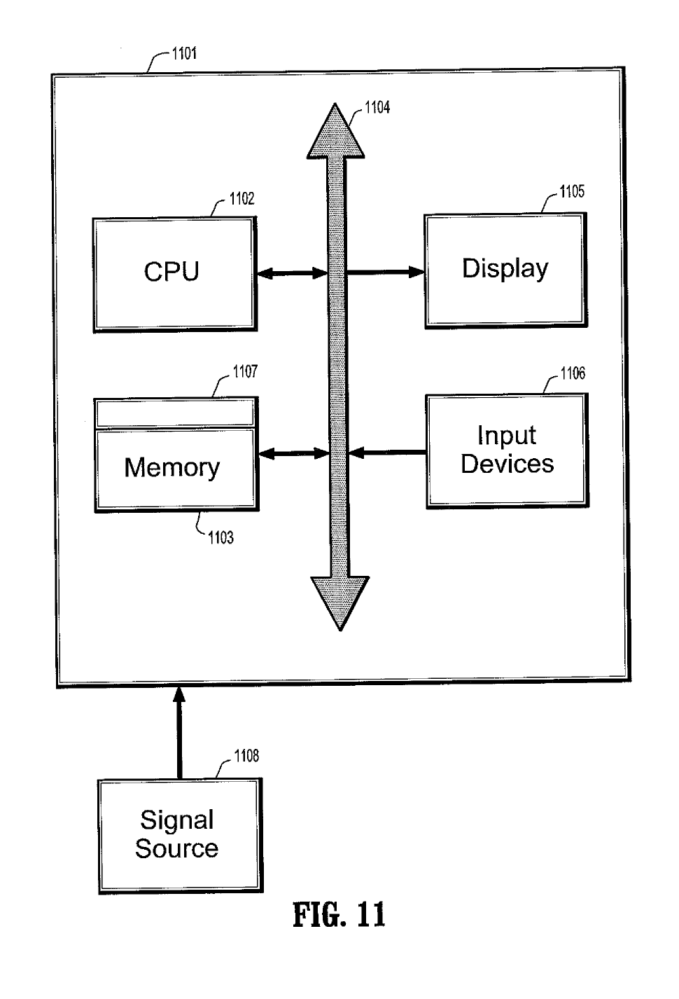

For example, FIG. 11 is a block diagram depicting an exemplary computer system for performing a method for detecting race conditions in web applications. The computer system 801 may include a processor 1102, memory 1103 coupled to the processor (e.g., via a bus 1104 or alternative connection means), as well as input/output (I/O) circuitry 1105-1106 operative to interface with the processor 1102. The processor 1102 may be configured to perform one or more methodologies described in the present disclosure, illustrative embodiments of which are shown in the above figures and described herein. Embodiments of the present disclosure can be implemented as a routine 1107 that is stored in memory 1103 and executed by the processor 1102 to process the signal from the signal source 1108. As such, the computer system 1101 is a general-purpose computer system that becomes a specific purpose computer system when executing the routine 1107 of the present disclosure.

It is to be appreciated that the term “processor” as used herein is intended to include any processing device, such as, for example, one that includes a central processing unit (CPU) and/or other processing circuitry (e.g., digital signal processor (DSP), microprocessor, etc.). Additionally, it is to be understood that the term “processor” may refer to a multi-core processor that contains multiple processing cores in a processor or more than one processing device, and that various elements associated with a processing device may be shared by other processing devices.

The term “memory” as used herein is intended to include memory and other computer-readable media associated with a processor or CPU, such as, for example, random access memory (RAM), read only memory (ROM), fixed storage media (e.g., a hard drive), removable storage media (e.g., a diskette), flash memory, etc. Furthermore, the term “I/O circuitry” as used herein is intended to include, for example, one or more input devices (e.g., keyboard, mouse, etc.) for entering data to the processor, and/or one or more output devices (e.g., printer, monitor, etc.) for presenting the results associated with the processor.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Although illustrative embodiments of the present disclosure have been described herein with reference to the accompanying drawings, it is to be understood that the disclosure is not limited to those precise embodiments, and that various other changes and modifications may be made therein by one skilled in the art without departing from the scope of the appended claims.

What is claimed is:

1. A computer readable storage medium embodying instructions executed by a processor for executing a rendering engine, the method comprising:
receiving computer readable code via a computer network; and
rendering the computer readable code as displayed content in a single thread of execution, the rendering engine characterized by a happens-before relation for a plurality of operations of the rendering engine in rendering the computer readable code.

2. The computer readable storage medium of claim 1, wherein the computer readable code comprises a plurality of atomic operations, and wherein the happens-before relation applies an ordering constraint on at least two of the atomic operations.

3. The computer readable storage medium of claim 2, wherein the plurality of atomic operations include a parse type operation and an execution type operation.

4. The computer readable storage medium of claim 1, wherein the computer readable code comprises a plurality of atomic operations, wherein each atomic operation is associated with a respective operation identifier, and wherein the happens-before relation is a binary relation on the operation identifiers of the atomic operations and applies an ordering constraint on at least two of the atomic operations.

5. The computer readable storage medium of claim 1, wherein the happens-before relation includes a plurality of rules ordering the atomic operations.

6. The computer readable storage medium of claim 5, wherein the plurality of rules constrain the rendering of the computer readable code.

7. A computer readable storage medium embodying instructions executed by a processor for executing a rendering engine, the method comprising:
receiving computer readable code via a computer network; and
rendering the computer readable code as displayed content in a single thread of execution, the rendering engine characterized by a model of logical memory locations for a plurality of memory-access operations of the rendering engine in rendering the computer readable code.

8. The computer readable storage medium of claim 7, wherein the computer readable code comprises a plurality of atomic operations, and wherein the model of logical memory locations define accesses to shared memory locations the that operations perform.

9. The computer readable storage medium of claim 8, wherein the accesses to shared memory locations include accesses on variable.

10. The computer readable storage medium of claim 8, wherein the accesses to shared memory locations include accesses on HTML elements.

11. The computer readable storage medium of claim 8, wherein the accesses to shared memory locations include accesses on event handlers.

12. A computer readable storage medium embodying instructions executed by a processor for executing a rendering engine, the method comprising:
executing a web application including at least two operations a single thread of execution;
generating an auxiliary map for a plurality of instrumentation accesses of the web application; and
detecting and reporting concurrent memory accesses of the web application as a race.

13. The computer readable storage medium of claim 12, further comprising generating a race report.

14. The computer readable storage medium of claim 12, wherein the instrumentation accesses include a happens-before relation applying an ordering constraint on the two operations.

15. The computer readable storage medium of claim 14, wherein the operations include a parse type operation and an execution type operation.

16. The computer readable storage medium of claim 15, wherein each operation is associated with a respective operation identifier, and wherein the happens-before relation is a binary relation on the operation identifiers of the operations and applies an ordering constraint on the operations.

17. The computer readable storage medium of claim 12, wherein the instrumentation accesses include a model of logical memory locations defining accesses to shared memory locations the that operations perform.

18. The computer readable storage medium of claim 17, wherein the accesses to shared memory locations include accesses on variable.

19. The computer readable storage medium of claim 17, wherein the accesses to shared memory locations include accesses on HTML elements.

20. The computer readable storage medium of claim 17, wherein the accesses to shared memory locations include accesses on event handlers.
